(19) United States
(12) Patent Application Publication
(10) Pub. No.: US 2013/0212857 A1
(43) Pub. Date: Aug. 22, 2013

(54) Wall-Mounted Home Fitness Training Equipment

(71) Applicant: Darren Donofrio, Plainfield, IL (US)

(72) Inventor: Darren Donofrio, Plainfield, IL (US)

(21) Appl. No.: 13/752,124

(22) Filed: Jan. 28, 2013

Related U.S. Application Data
(63) Continuation of application No. 13/016,750, filed on Jan. 28, 2011.
Application No. 13/016,750 is a continuation-in-part of application No. 12/228,998, filed on Aug. 19, 2008, now abandoned.

(51) Int. Cl. B23P 19/00

(52) U.S. Cl. CPC B23P 19/00
USPC 29/428

(57) ABSTRACT

An overall fitness trainer and can be a wall mounted unit that can utilize clip resistance bands as well as other techniques. These bands generally clip on the unit and onto different handles, bars and attachments to perform exercises. The unit can have a removable/adjustable pull up bar, dip bar and seat. It also includes a spring loaded, pull pin carriage that moves freely up and down a vertical spine. This allows for easy adjustment of the carriage and allows the user to attach the bands at multiple angles, widths and levels. This in turn increases the number of exercises the user can perform on the unit. The unit can be attached to the wall with lag bolts into two or more studs.

This is a continuation-in-part of co-pending application Ser. No. 12/228,998 filed Aug. 19, 2008. Application Ser. No. 12/228,998 is hereby incorporated by reference.

### BACKGROUND

1. Field of the Invention

The present invention relates generally to the field of home exercise equipment and more particularly to a wall-mounted home fitness unit with removable parts that adapts to numerous different exercises.

2. Description of the Prior Art

It is known in the art to provide exercise equipment into the home which can be wall-mounted. For example, U.S. Pat. No. 4,339,125 teaches a single column exercising apparatus using a stack of weights. U.S. Pat. No. 5,383,525 teaches a wall-mounted shower exercise machine used for stretching muscles. U.S. Pat. No. 4,402,504 teaches an adjustable exercise device that uses a two-ended cable for providing resistance to pulling. U.S. Pat. No. 6,328,679 teaches a wall-mountable device that uses a horizontal hinge rod assembly with springs. U.S. published application 2001/0004624 teaches a body exerciser that leans against a wall. U.S. published application 2003/0158024 teaches a door mounted exercise device that allows pulling on bungee cords. None of these prior art systems allow parts to be removed and exchanged for different exercises. Also most of the prior art wall-mounted home systems do not allow adjustment for different users and for causing different muscles to be exercised. It would be advantageous to have a wall-mounted, home exercise system that overcomes the difficulties of prior art systems.

### SUMMARY OF THE INVENTION

The present invention relates to an overall fitness trainer and can be a wall mounted unit that can utilize clip resistance bands as well as other techniques. These bands generally clip on the unit and onto different handles, bars and attachments to perform exercises. The unit can have a removable/adjustable pull up bar, dip bar and seat. It also includes a spring loaded, pull pin carriage that moves freely up and down a vertical spine. This allows for easy adjustment of the carriage and allows the user to attach the bands at multiple angles, widths and levels. This in turn increases the number of exercises the user can perform on the unit. The unit also typically has an o ring that attaches through the arm of the pull up attachment as well as a ½ O-ring at the bottom of the unit again increasing the number of exercises the user can perform. The unit can be attached to the wall with lag bolts into two or more studs with two being preferred. Some embodiments of the present invention have an adjustable swivel foot that takes the stress off of the lag bolts and also adds to the overall load capacity of the unit. The present invention typically has an optional telescoping central vertical spine that splits in two pieces to make the unit easier to ship. The central vertical spine allows attachments to be added and removed using spring loaded pins or plunger pins. Various embodiments of the invention can have an oscillating and telescopic bench, a dip bar, a seat, a knee stabilizer and a foot rest. All of these accessories can be attached and removed to the central spine adding to the versatility and scope of exercises that can be performed. The present invention is suitable for physical therapy/rehabilitation facilities, commercial gyms and schools, as well as home use.

### DESCRIPTION OF THE FIGURES

Attention is directed to several figures that illustrate the concepts of the present invention:

FIG. 1 shows a perspective view of an embodiment of the present invention with several accessories attached.

FIG. 2 shows the embodiment of FIG. 1 with several metal accessories on the vertical spine.

FIG. 3 shows a side view of the embodiment of FIG. 2.

FIG. 4 shows a front view of the embodiment of FIG. 2.

FIG. 5 shows a user facing the unit performing an exercise.

FIG. 6 shows a particular embodiment of a two-piece spine.

FIG. 7 shows a detail of a removable horizontal bar.

FIG. 8 shows a detail of a removable arm bar.

FIG. 9 shows an embodiment of the invention with an ankle cuff.

FIG. 10 shows an embodiment of the invention with a baseball bat.

FIG. 11 shows an embodiment of the invention with a baseball.

FIG. 12 shows an embodiment of the invention with the bench attached and extended.

FIG. 13 shows an embodiment of the invention arranged for chest presses.

FIG. 14 shows an embodiment of the invention arranged for chin-ups.

FIG. 15 shows an embodiment of the invention arranged for curls.

FIG. 16 shows an embodiment of the invention with a football.

FIG. 17 shows an embodiment of the invention with a golf club.

FIG. 18 shows an embodiment of the invention with a plyo ball.

FIG. 19 shows an embodiment of the invention arranged for a single curl.

FIG. 20 shows an embodiment of the invention arranged for a squat.

FIG. 21 shows an embodiment of the invention arranged for a tricep exercise.

FIG. 22 shows a baseball bat handle with a ring.

FIG. 23 shows a baseball with a ring.

FIG. 24 shows a medicine ball with a ring.

FIG. 25 shows boxing gloves with rings.

FIG. 26 shows a straight bar.

FIG. 27 shows a football with a ring.

FIG. 28 shows a curl bar.

FIG. 29 shows a squat belt.

FIG. 30 shows a band with clips.

FIG. 31 shows a golf club handle.

Several drawings and illustrations have been presented to aid in understanding the present invention. The scope of the present invention is not limited to what is shown in the figures.

### DESCRIPTION OF THE INVENTION

The present invention relates to a wall-mountable home fitness or exercise apparatus and method that allows a user to perform numerous exercises on the same piece of equipment by simply changing out accessory parts. The unit generally has a single rigid central spine. A two inch rectangular steel channel is preferred; however, any strong vertical member can be used. Onto this spine, a group of removable accessories can be attached or removed at will. Several different elastic cord attachments and attachment points inject resistance into various exercises. At least the following accessories can be used with the present invention: straight bar with ½ O-ring and outer attachments, leg press, ankle cuffs, Ab blaster/leg extension, single Handle, curl bar, rope, bench, step, Ab slings, Plyo ball, boxing gloves w/sewn in D-ring, base ball bat handle, golf handle, baseball/softball and football. It should be noted that the abbreviation Ab means abdomen.

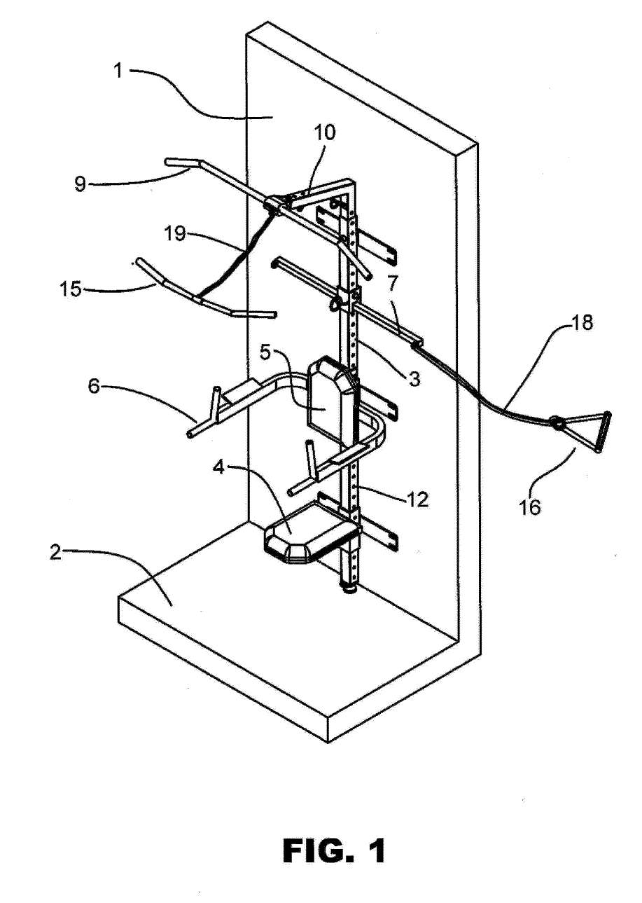

Turning to FIG. 1, a portion of a wall 1 and a floor 2 can be seen. A vertical spine 3 is securely attached to the wall 1. At the top of the spine 3, an outward hanging portion 10 allows attachment of various items such as a bungie 19 and bar 15, a boxing bag or punching bag, or other device. Further down the spine 3, a horizontal bar 7 is shown with a bungie 18 and hand pull 16. Further down, a set of arm bars 6 and back rest 5 can be seen. Still further down, a seat 4 is attached. Each of these attachments shown can slide up and down on the spine 3. In addition, each attachment or accessory can be removed using a pin or spring-loaded pull pin, where the pin inserts in a hole 12 in the spine 3. In particular, any of the accessories can be arranged vertically in any order. The order shown in FIG. 1 is simply to illustrate a particular configuration of the device.

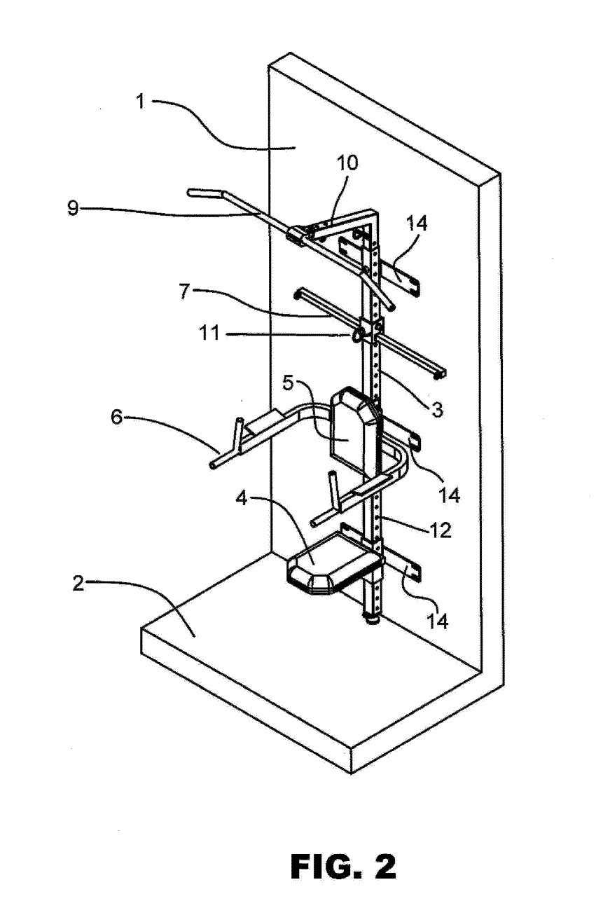

FIG. 2 shows the embodiment of FIG. 1 without the bungies. Here several stud mounts or stud plates 14 can be seen. These are typically chosen to reach between two studs so that secure mounting can be made with a pair of lag bolts on each of these stud mounts 14. The embodiment of FIG. 2 has three stud mounts 14 vertically along the spine 3. Shown also in FIG. 2 is a ring 11 attached to the center of the horizontal bar 7.

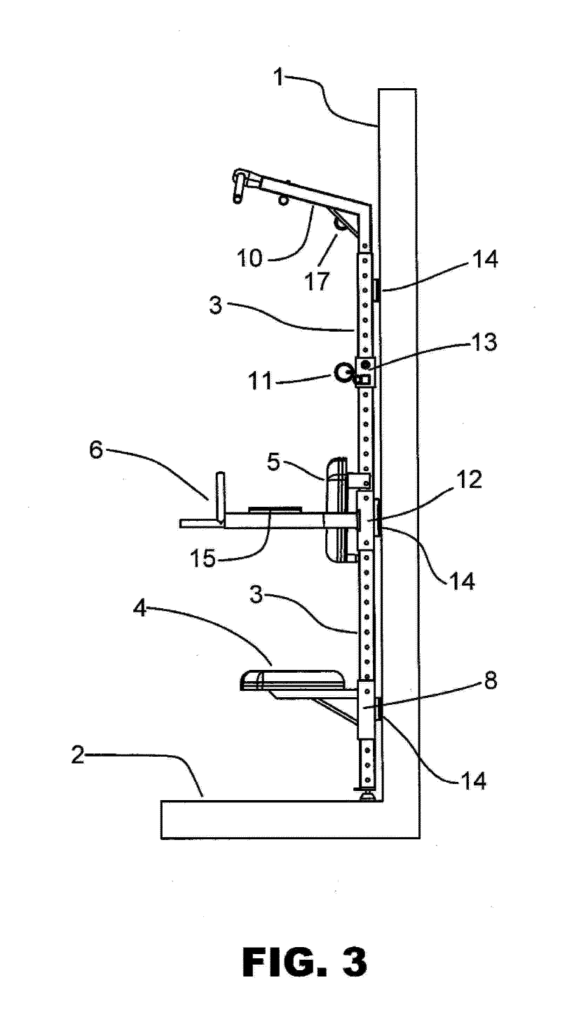

FIG. 3 shows a side view of the embodiment of FIGS. 1-2. The stud mounts 14 can be clearly seen against the wall 1. Each of the attachments or accessories can have a partial or full channel to fit around the spine 3. The seat has a channel 8; the arm bar a channel 12; the horizontal bar has a channel 13. The top extension 10 can also be removed vertical from the spine 3. In FIG. 3, the ring 11 on the horizontal bar can be seen as well as a ring or half-ring 17 on the top extension 10. Other rings or attachments may be built into various accessories.

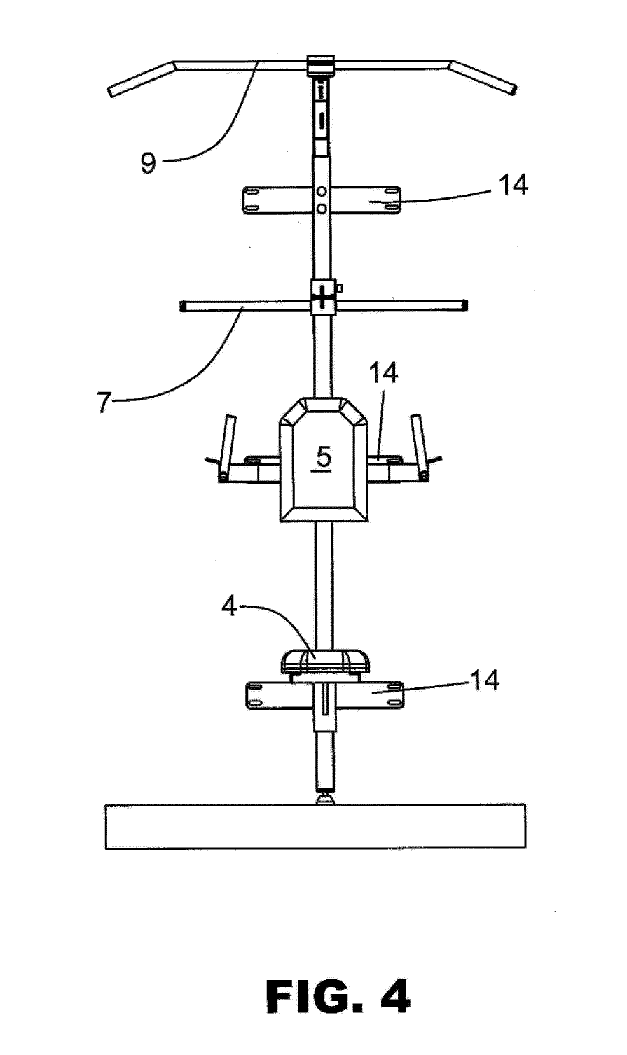

FIG. 4 shows a straight-on front view of the embodiment of FIGS. 1-3. The stud mounts 14 can be seen. It should be noted that the stud mounts 14 can be of any length to fit any types of studs or to attach to more than two studs. While two studs are preferred for strength and ease of mounting, any number of studs is within the scope of the present invention. FIG. 4 also shows a pull-up bar 9 mounted to the top of the unit onto the top extension 10 (see FIGS. 1-3).

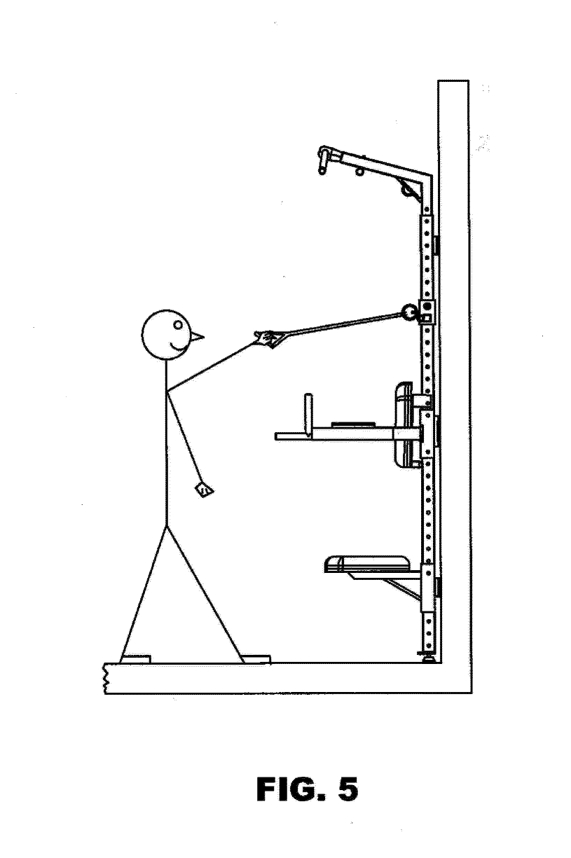

FIG. 5 shows a stick-figure user performing one particular exercise. It should be noted that the apparatus and method of the present invention allows numerous different exercises to be performed. A complete list of exercises supported by the present invention can be found at the end of this disclosure.

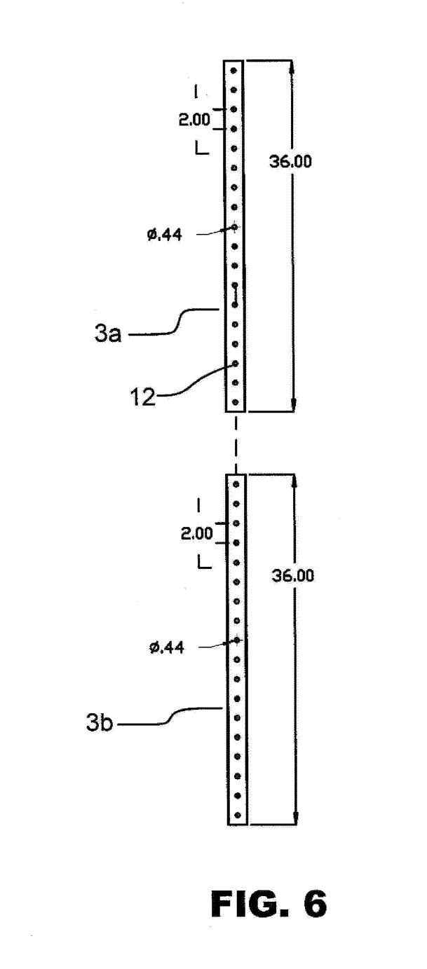

FIG. 6 shows a detail of a particular embodiment and realization of the vertical spine 3. This particular embodiment allows the spine 3 to be split into an upper part 3a and a lower part 3b for ease of packing and shipping. The two parts of the spine can be coupled together with bolts for strength or by any other strong coupling method. The particular embodiment shown in FIG. 6 has dimensions to aid in the understanding of the invention. These dimensions are for example only; any dimensions are within the scope of the present invention. These are preferred dimensions; however, many different dimensions may be used. In this particular example, both the top and bottom half-spines are 36 inches long. Each has holes 2 inches apart, and each hole is 0.44 inch in diameter.

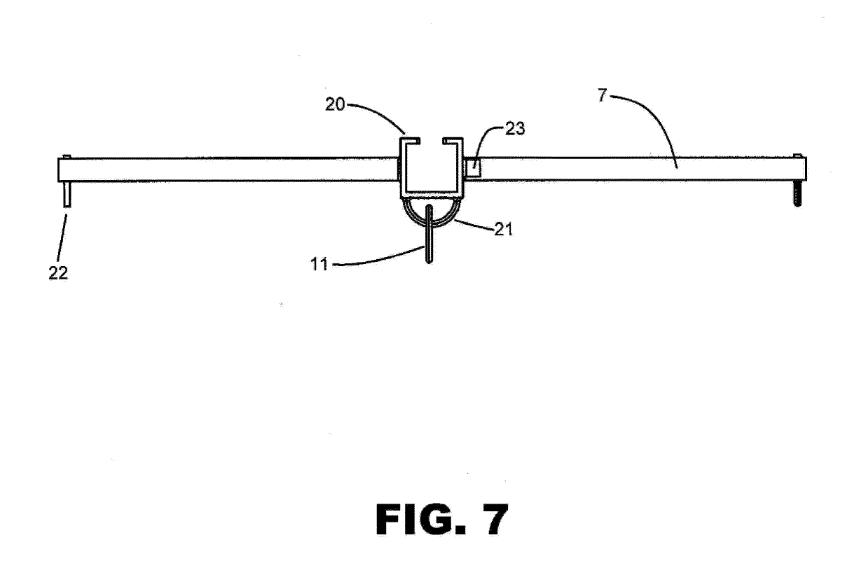

FIG. 7 shows a detail of an embodiment of the horizontal bar 7. Here a partial channel 20 allows it to be inserted and removed from the vertical spine 3 (shown in FIG. 2). A spring-loaded pull pin 23 allows the bar 7 to be moved vertically along the spine 3 and to be removed. Each end of the bar 7 has attachment points 22 for bungies which can also be called stretch cords, or other exercise accessories. The center of the bar 7 can be optionally equipped with a half-ring 21 and a full ring 11.

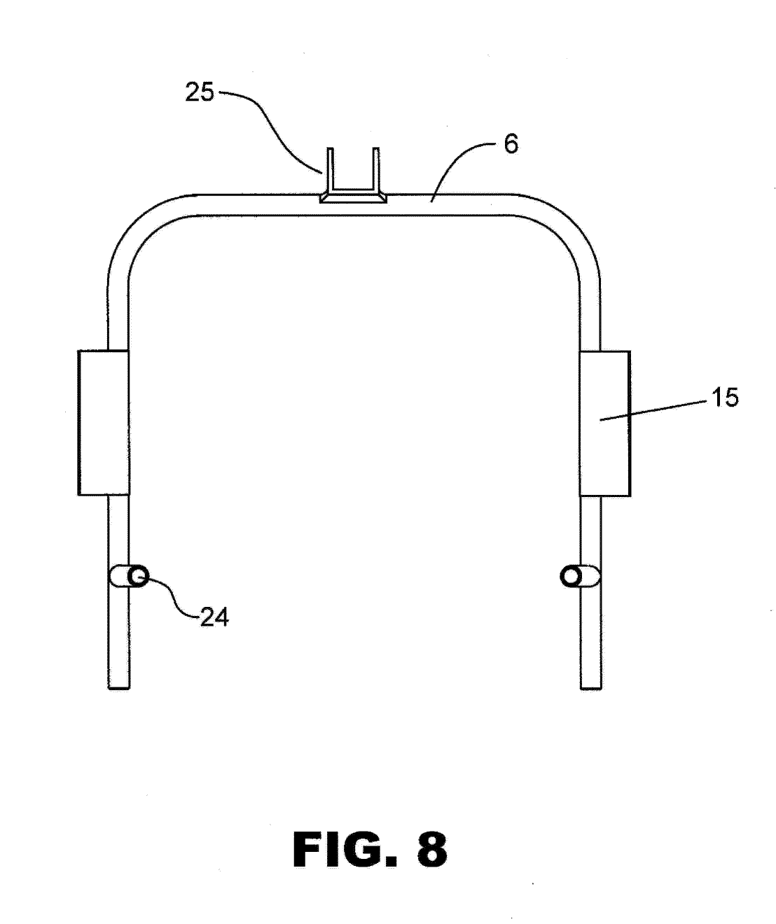

FIG. 8 shows a detail of an embodiment of an arm bar 6. The bar 6 can have flat plates 15 which can hold pads or soft rolls to protect the arm. A half channel 25 allows attachment and removal from the spine 3 (see FIG. 2). Fittings 24 can hold vertical handles.

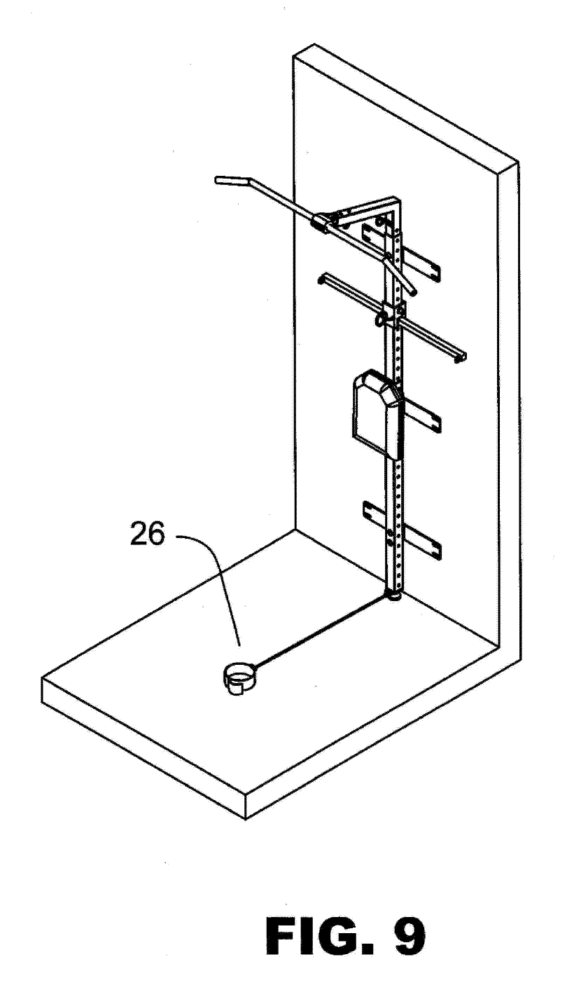

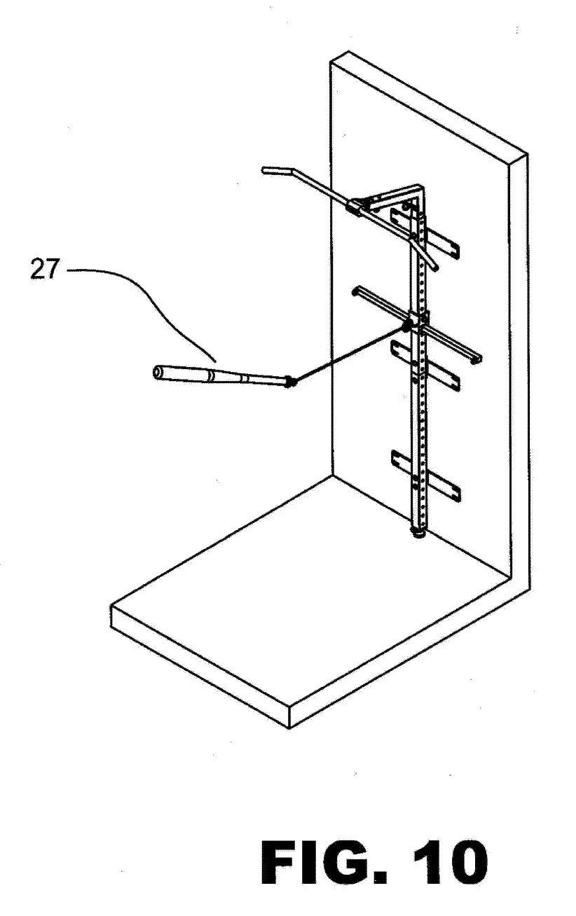

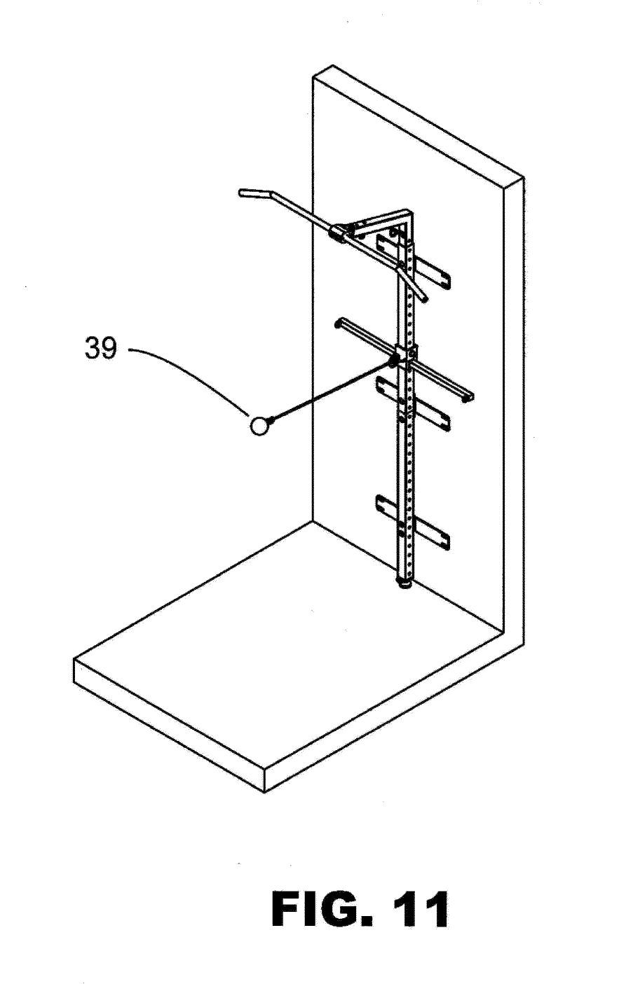

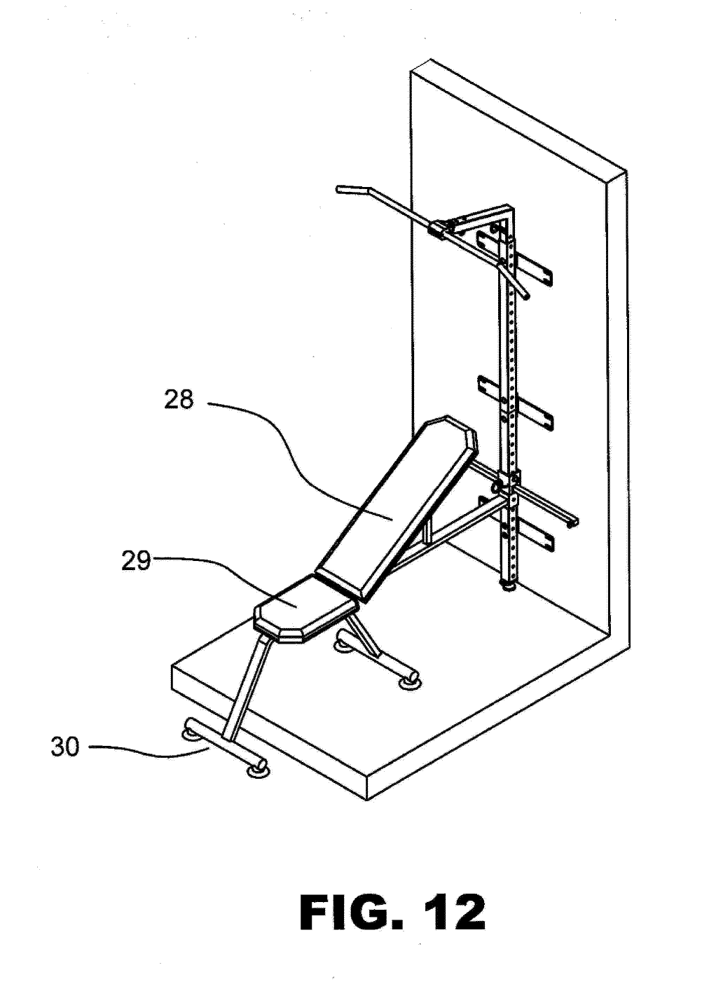

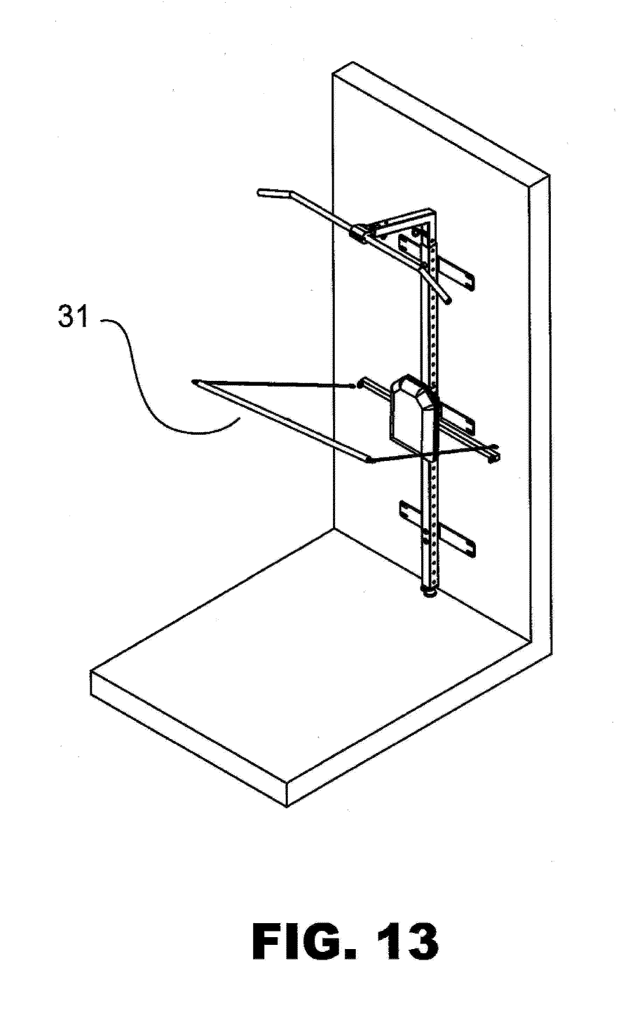

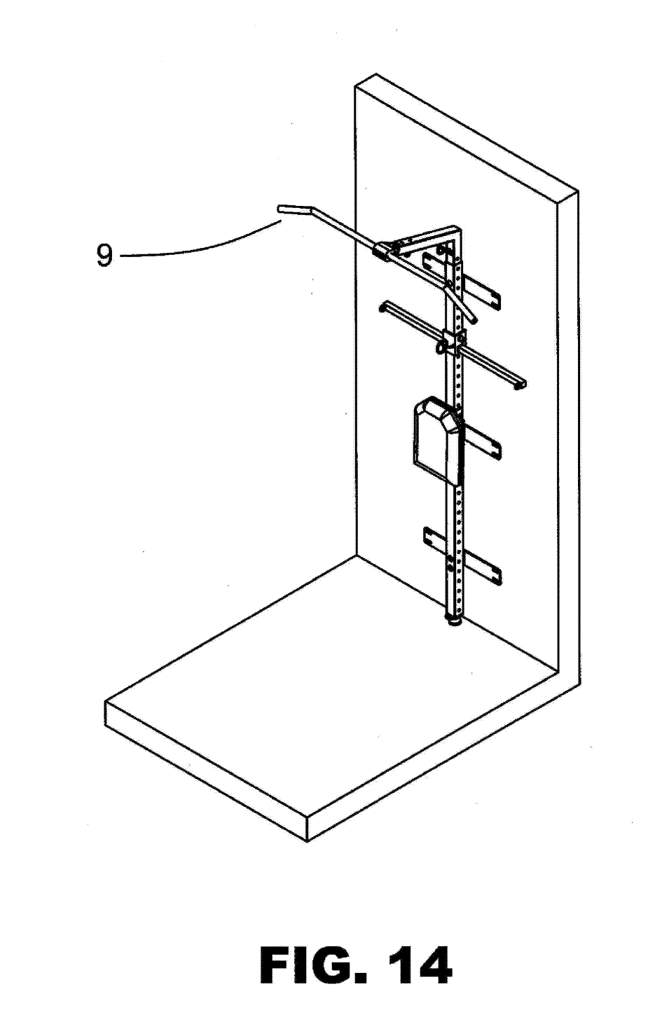

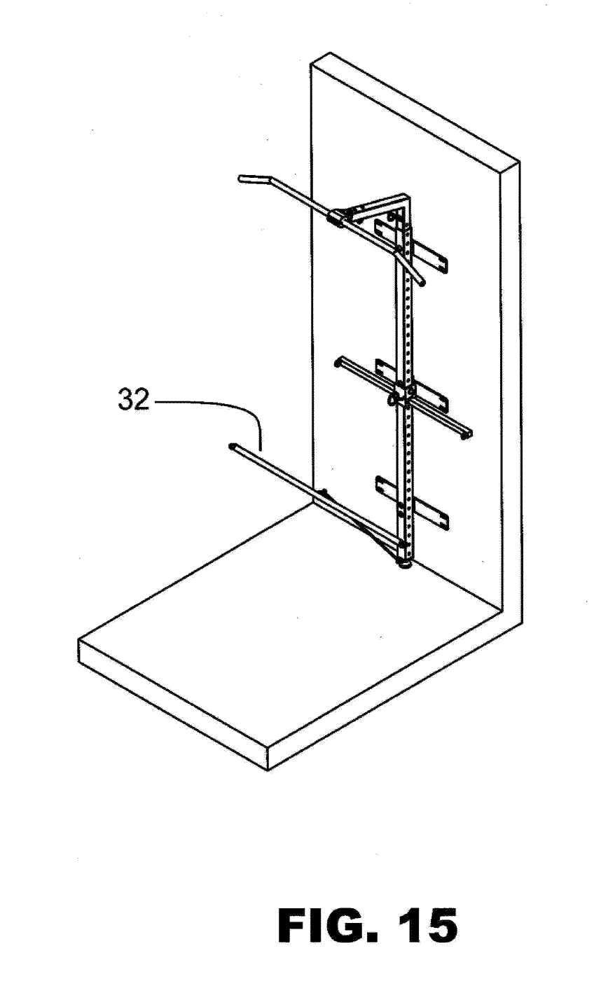

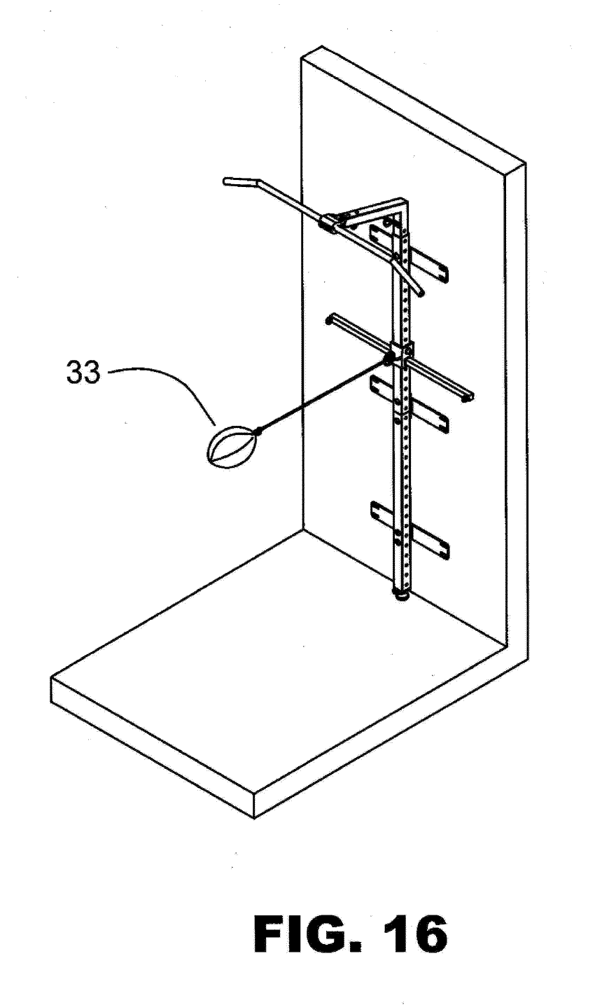

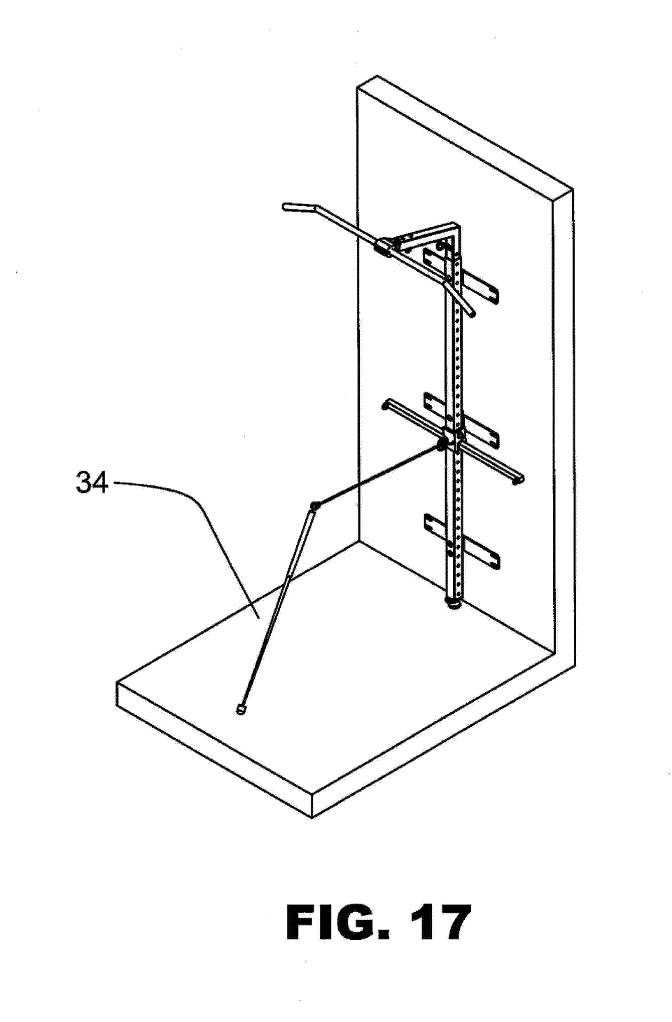

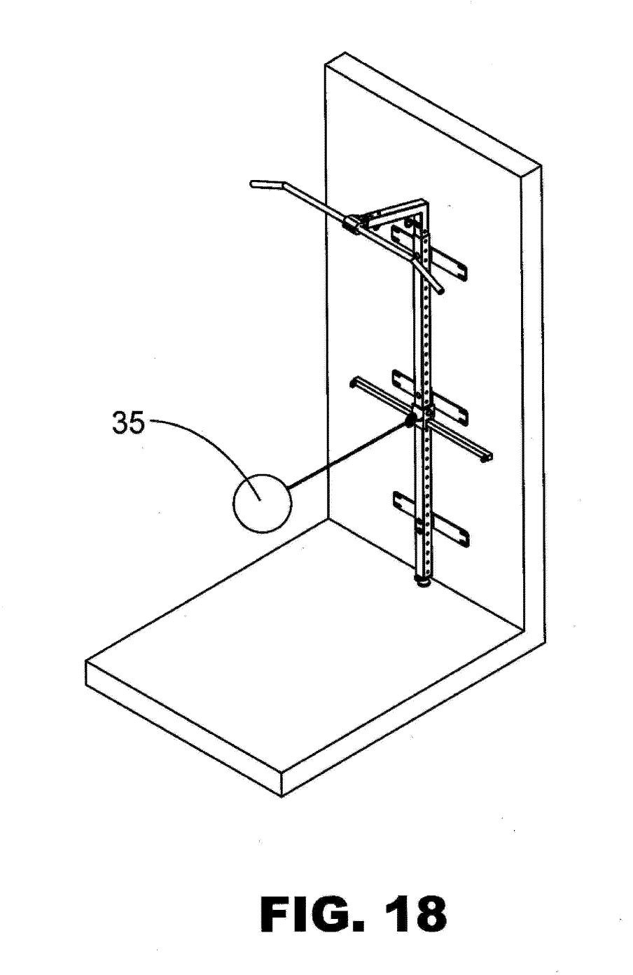

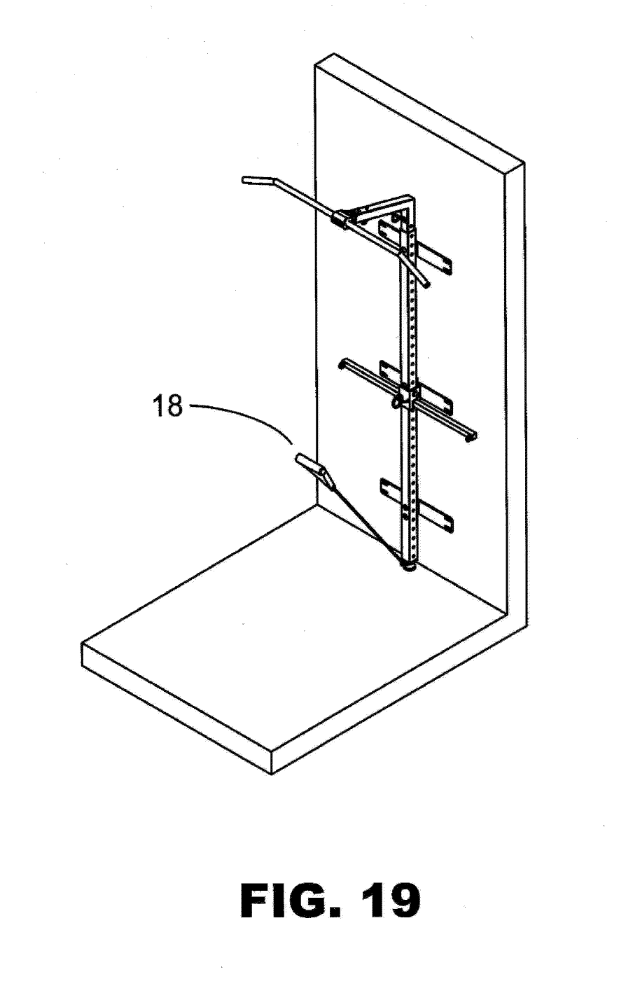

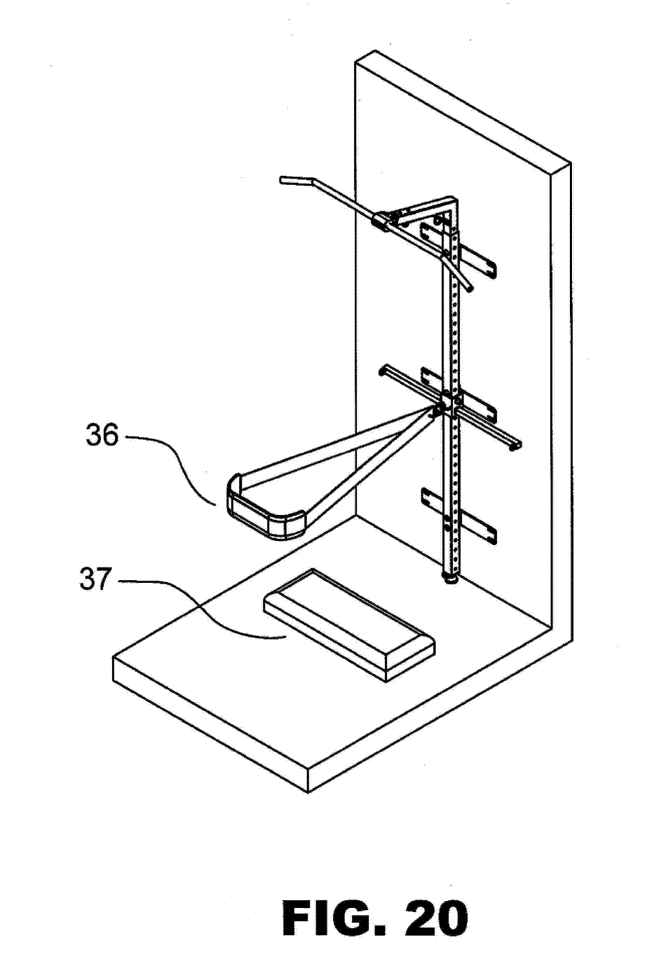

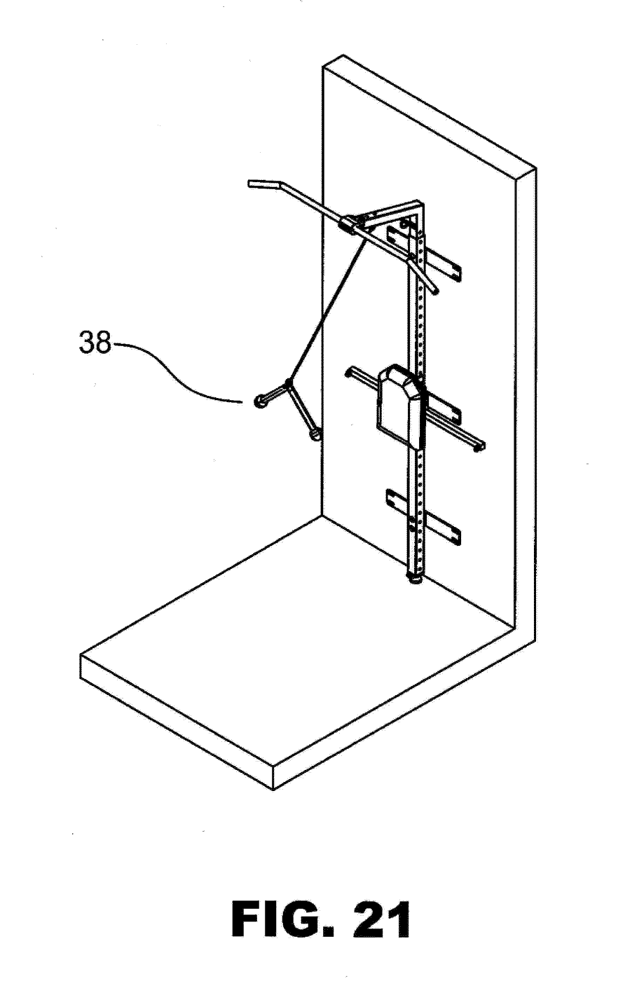

FIG. 9 shows an embodiment of the invention with an ankle cuff 26. Here the user stands and can pull the cuff 26 against a bungie. FIG. 10 shows an embodiment with a baseball bat 27. A standing user can swing the bat 27 into a bungie. FIG. 11 shows a baseball 39 attached to a bungie. A standing user can practices throwing the ball 39 against the force of the bungie. FIG. 12 shows an embodiment of the invention fully benched. A seat 29, back 28 and legs 30 from a sitting bench that can be used in many exercises or with weights. The back 28 and seat 29 can be adjusted both in angle and height. FIG. 13 shows an arrangement of the device set up for chest presses. A bar 31 can be pressed outward against a bungie. FIG. 14 shows an arrangement set up for chin-ups. A standing user can chin themselves vertically on the bar 9. FIG. 15 shows a set up for curls using the bar 32. FIG. 16 shows an embodiment of the invention with a football 33. A standing user can pass the football 33 against the force of the bungie. FIG. 17 shows a set up with a golf club 34. Here an individual can swing the club 34 into the force of the bungie. FIG. 18 shows a set up with a plyo ball 35. The user can manipulate the ball 35 against the force of the bungie. FIG. 19 shows a set up for a single curl using a hand grip 18 that works against the force of a bungie. FIG. 20 shows an embodiment of the invention set up for squats. A strap 36 and pad 37 allow the user to perform squats. FIG. 21 shows a setup with a special handle 38 for a tricep exercise.

As has been described, the present invention includes many different attachments and exercise devices that may be attached with snaps or rings, with or without stretch cords.

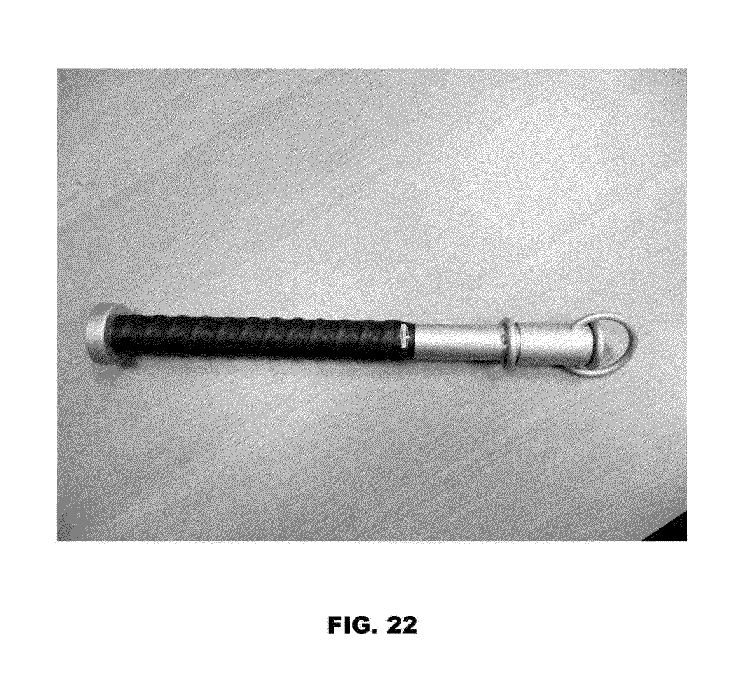

FIG. 22 shows a baseball bat handle that is a streamlined version of a full length bat. The bat is cut off so that the user holds only the handle. A ring can attached to a stretch cord and onto any part of the apparatus.

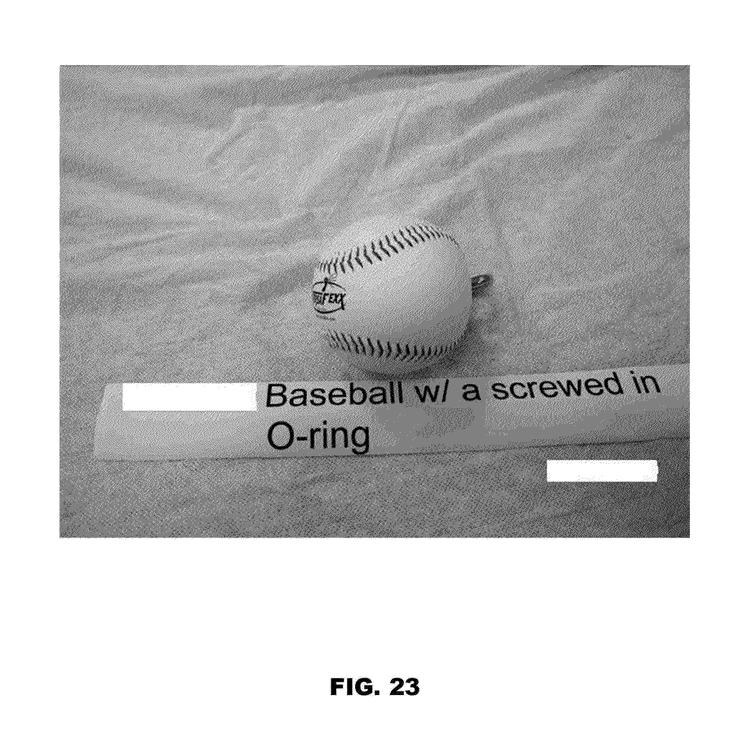

FIG. 23 shows a baseball with an embedded 0-ring. This can be attached with a clip to a stretchable cord and to any piece of the apparatus. The ball can be gripped and a user can go through a pitching action.

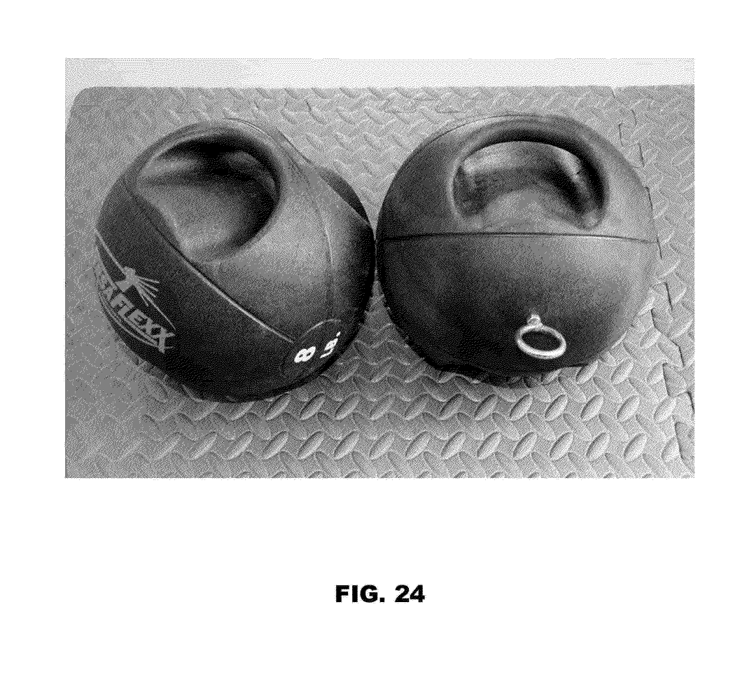

FIG. 24 shows a handled medicine ball with a ring that can be attached with a stretch cord to any part of the apparatus.

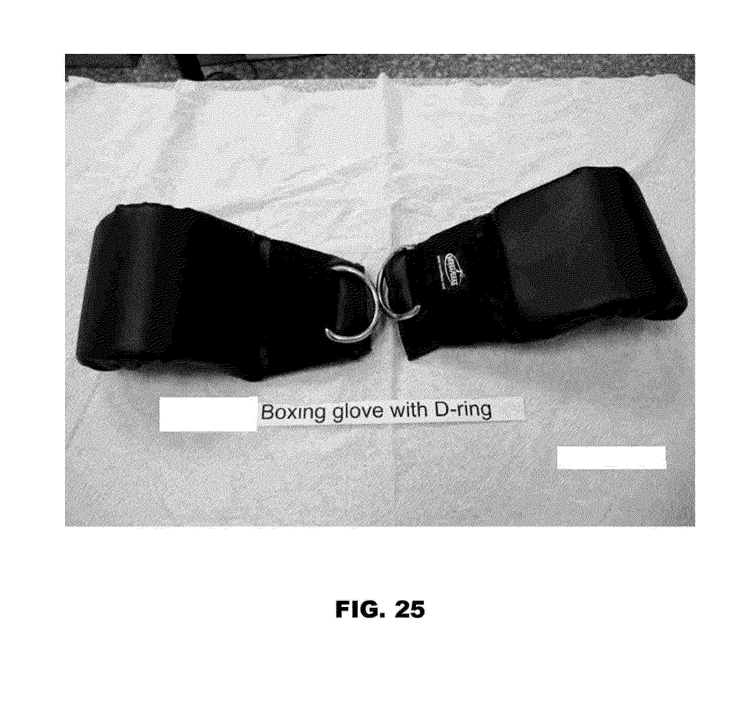

FIG. 25 shows a pair of boxing gloves that can have rings that can be attached with a stretch cord to any part of the apparatus. A user can thus box against the force of the cord strengthening arm and wrist muscles.

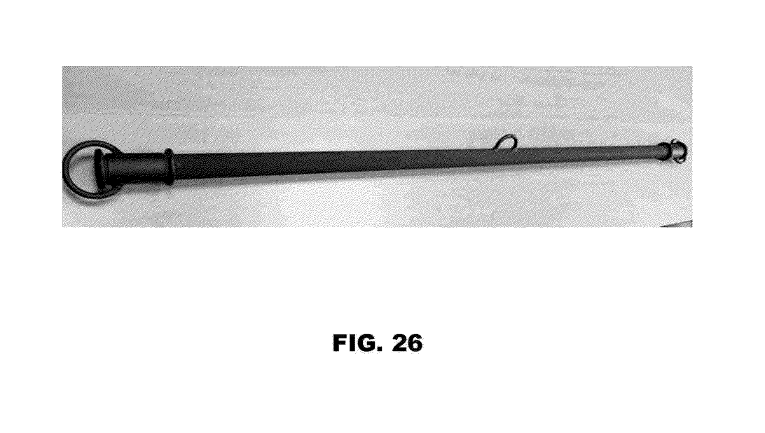

FIG. 26 shows a straight bar that can be used with the present invention.

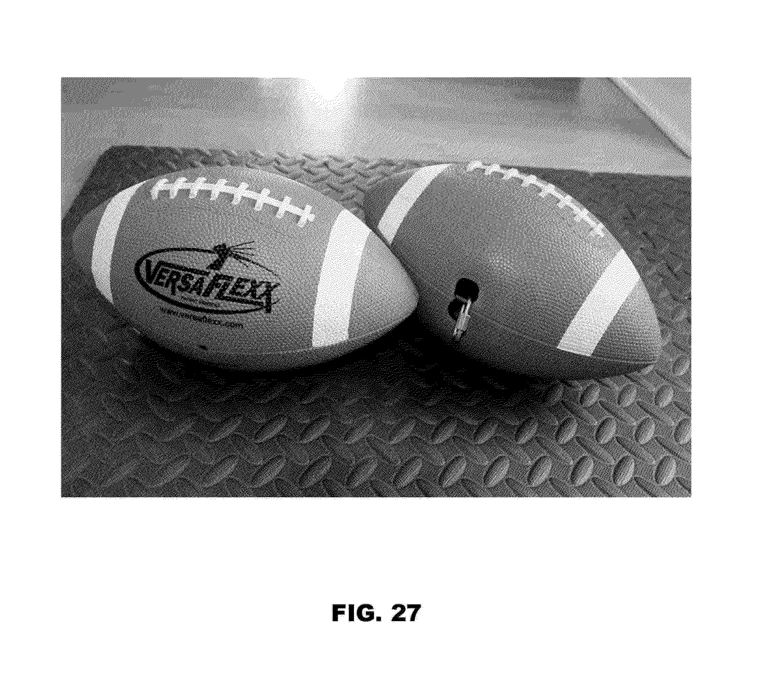

FIG. 27 shows a football with a ring that can be moved against the force of the cord such as in a pass movement strengthening the arm muscles.

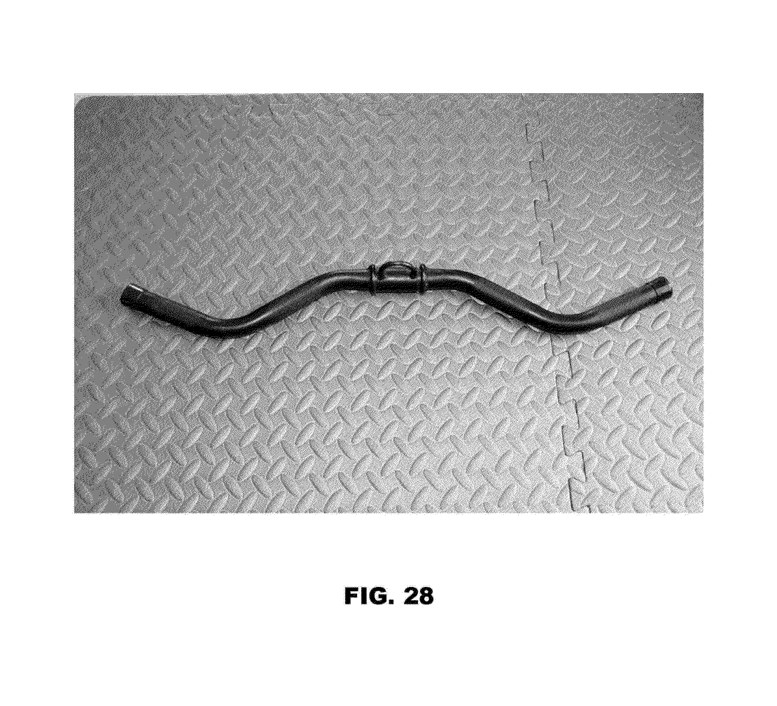

FIG. 28 shows a curl bar that can be used with the present invention.

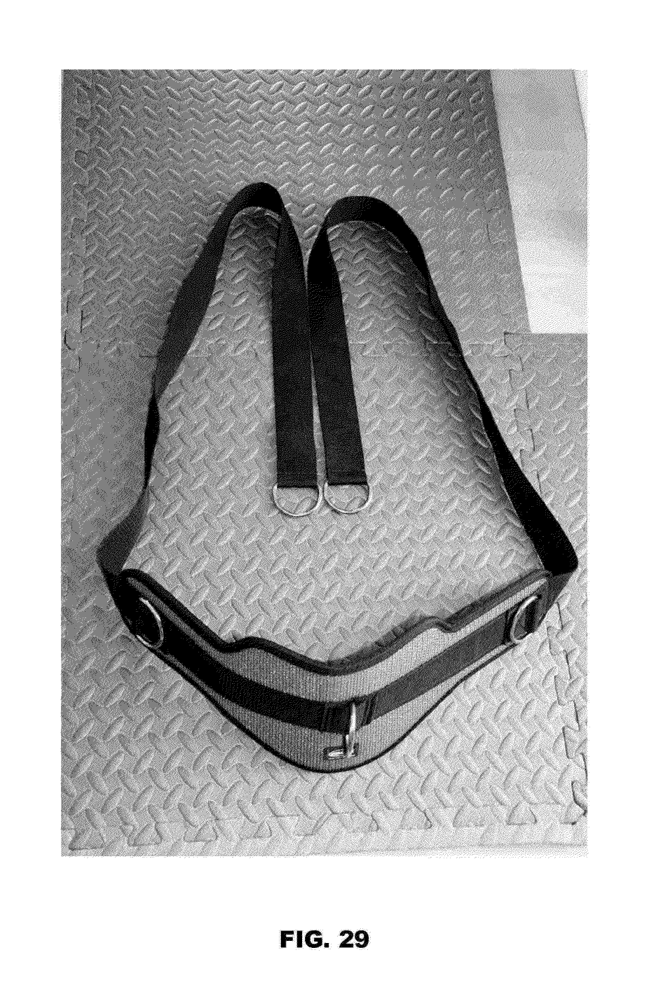

FIG. 29 shows a squat belt that can be worn around the waist using the straps shown. The belt can then be attached to the apparatus at one or several points with stretch cords. The belt can be used for squat or other exercises simply be setting where the cords are attached to the apparatus.

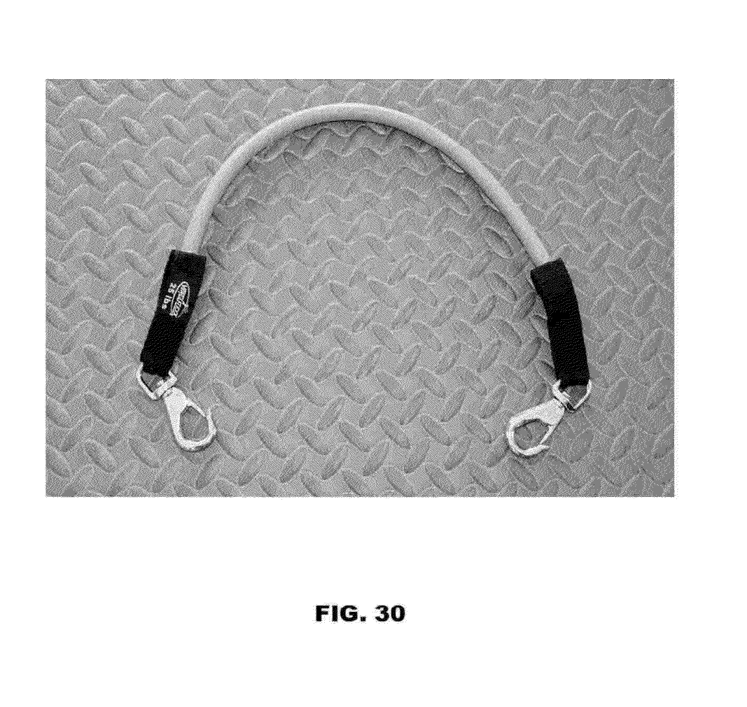

FIG. 30 shows a typical stretch cord band with clips on each end. This type of band can be attached on one end to any of the accessories described, and on the other end to any part of the apparatus appropriate for a particular exercise.

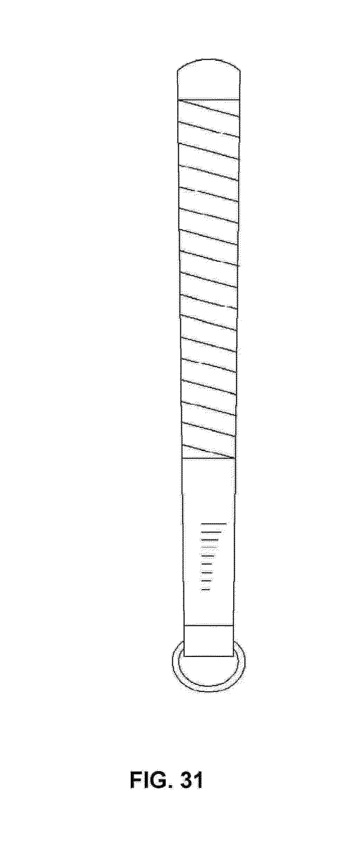

FIG. 31 shows a golf club handle that is cut off in a manner similar to the baseball handle of FIG. 22. Many other accessories can be made like the baseball handle of FIG. 22 or the golf club handle of FIG. 31. In particular, a hockey stick can be cut off with an O-ring placed at the bottom part of the stick just above the blade, and a lacrosse stick can be made in a similar way by cutting it short and placing an O-ring on the back side just underneath the end.

The present invention forms a complete system that can accommodate numerous exercises by simply changing the arrangement. The frame can mount simply to the wall in a garage, house or other building.

Several descriptions and illustrations have been presented to aid in understanding the present invention. One skilled in the art will realize that numerous changes and variations are possible without departing from the spirit of the invention. Each of these changes and variations is within the scope of the present invention.

### List of Exercises Supported by the Present Invention

### Chest Exercises

1 Arm Standing Chest Press w/Handle

Standing Chest Press w/Straight Bar

Close Grip Bench Press Curl Bar

Standing Chest Fly w/Handles

Seated Incline Bench Press Straight Bar

Seated Incline Bench Fly w/Handles

Seated Bench Press w/Straight Bar

Seated Bench Press w/Handles

Seated Bench Flies w/Handles

Dips on Dip Bar attachment

Single Arm Chest Fly W/Handle Perpendicular to Machine

2 Handled Chest Squeeze

Pullovers w/handles or straight bar

Cable Cross Over Handles

Elevated Resistance Push Ups(Feet on Bench)

### Back Exercises

High Standing Row Straight Bar

Reverse Grip High Standing Row Straight Bar

One arm high row handle

One arm low row handle

Straight Arm Pull Downs Straight Bar

Low Pulley Row sitting on Step Handle or Straight Bar

Wide Handled Reverse Fly Handles

Seated One Arm Pull Down Handle

Seated Pulldown Straight Bar

Wide Bent Over Row Straight Bar

Good Mornings Straight Bar or Rope

Pull Ups

Chin Ups

Back Hyper extensions

Lat Pull Over on Bench Handles

### Biceps

Standing Curls Straight Bar

Standing Curls Curl Bar

1 Arm Alternating Standing Curl Handles At multiple angles

2 Arm Standing Curls Handles

1 Arm Hammer Curl

1 Arm Handled Concentration Curl

High Handled Curl

High Curl Bar

Seated Curl Back To Machine

Incline Handled Curl

### Triceps

Push Downs Curl Bar

Push Downs Straight Bar

Push Downs Rope

Incline French Presses Curl Bar or Handles

Flat French Presses Curl Bar or Handles

Reverse Grip Pushdowns Curl Bar

1 Arm Seated Tricep Extensions

1 Arm Handled Reverse Grip Pushdown

Standing Tricep Extension Back To Machine Rope/Curl Bar

1 Arm Kick Backs Handle

2 Arm Kick Backs Facing Machine Curl Bar

Dips

Bench Dips

Cross Body Tricep Extension Handles

Close Grip Bench Press Bar

### Shoulders

Seated Shoulder Press Bar

1 Arm Handled Shoulder Press

1 Arm Handled Arnold Shoulder Press

Upright Rows Bar

Upright Rows Handle

1 Arm Handled Lateral Raises

2 Arm Straight Bar Frontal Raises

1 Arm Handled Frontal Raises

Bent Over Flies Handled

Handled External Shoulder Rotation

Handled Shoulder Rotation Lying Down

Standing Military Press Bar

Handled Internal Shoulder Rotation

Shrugs Bar

Elevated Push Ups W/or W/O Band Resistance

### Legs

Squat Bar W/Resistance

Squat In U-Can Squat Belt

1 Legged Squat In U-Can Squat Belt

Squats W/Handled Resistance

Lunges Bar

Lunges Handled Resistance

Standing Leg Curls

Toe Raises In U Can Squat Belt

Toes Raises Bar/Handles

Straight Leg Dead Lift Bar

Standing Leg Curl Ankle Strap

Standing Leg Kick Ankle Strap

Standing Knee Ups Ankle Strap

Lying Down Single Leg Raise Ankle Strap

Lying On Side Single Leg Raise

Leg Raises Incredi-ab Attachment/Ankle Strap

Standing Leg Abductor Ankle Strap

Twisting Leg Raises on Dip Attachment

Seated Leg Extensions Incredi-ab or Ankle Strap

Standing Leg Adductor Ankle Strap

### Abs

Crunches On Knees Facing Unit Rope

Resistance Crunches on Bench Rope/Multiple Angles

Crunches With Exercise Ball and Band Resistance

Hanging Leg Raises Pull Up Bar

Knee Ups Sitting on Bench Incredi-ab Attachment

Oblique Knee Ups on Bench Incredi-ab Attachment

Bridged Leg Lifts Ankle Strap

Russian Twist Medicine Ball & Resistance Bands

Diagonal Chops Medicine Ball & Resistance Bands

Forward Facing Chops Medicine Ball & Resistance Bands

Standing Ann Rotation Handle

Standing Rotational Chops Ball Handle

Captain's Chair Exercise on Dip Bar Back Support

Resistance Side Bends

Seated Ab Twist

### Sports Specific

Baseball Throw

Softball Throw

Football Throw

Golf Swing

Baseball Swing

Boxing Punch Training Gloves w/D Ring

Heavy Bag Station Attach Bag to Pull Up Arm

Kicking Training Ankle Bands

1. A method providing home fitness exercises comprising:
attaching a telescoping vertical spine with top and bottom portions to an interior wall;
removably attaching an extension member to the top portion of said vertical spine;
removably attaching at least one of a plurality of exercise accessories to said vertical spine or said extension member, each including a ring adapted to be clipped to a first end of a stretch cord, a second end of said stretch cord being attached to said vertical spine or extension member;
wherein said plurality of removable exercise accessories includes at least:
a curl bar and a straight bar;
a baseball bat or baseball bat handle and a golf club or golf club handle;
a handled medicine ball;
a hockey stick or a hockey stick handle and a lacrosse stick or a lacrosse stick handle;
a squat belt;
a football and a baseball.

2. The method of claim 1 wherein said plurality of removable exercise accessories further includes an ankle cuff.

3. The method of claim 1 further comprising attaching an adjustable seat and back rest to said vertical spine.

4. The method of claim 1 further comprising attaching a telescoping bench to said vertical spine.

5. The method of claim 18 wherein said telescoping bench has a footrest.

6. A method providing home fitness exercises comprising:
fabricating a 2-part telescoping vertical spine with top and bottom portions attachable to an interior wall;
fabricating a removable extension member attachable to the top portion of said vertical spine;
fabricating a plurality of exercise accessories attachable to said vertical spine or said extension member, each including a ring adapted to be clipped to a first end of a stretch cord, a second end of said stretch cord being attached to said vertical spine or extension member;
wherein said plurality of removable exercise accessories includes at least:
a curl bar and a straight bar;
a baseball bat or baseball bat handle and a golf club or golf club handle;
a handled medicine ball;
a hockey stick or a hockey stick handle or a lacrosse stick or a lacrosse stick handle;
a squat belt and an ankle cuff;
a football and a baseball;
boxing and shipping said vertical spine, said extension member and said plurality of removable exercise accessories.
